(19) United States
(12) Patent Application Publication
(10) Pub. No.: US 2019/0266263 A1
(43) Pub. Date: Aug. 29, 2019

(54) SYSTEM AND METHOD FOR PROVIDING DIGITAL CONTENT ASSOCIATION WITH AN OBJECT

(71) Applicant: Samsung Electronics Co., Ltd., Suwon-si (KR)

(72) Inventors: Long Jiang, Santa Clara, CA (US); Tao Ma, Milpitas, CA (US); Julie Zhu, Saratoga, CA (US)

(21) Appl. No.: 15/961,451

(22) Filed: Apr. 24, 2018

Related U.S. Application Data
(60) Provisional application No. 62/634,676, filed on Feb. 23, 2018.

(51) Int. Cl. G06F 17/30; G06K 9/00; G06F 21/62

(52) U.S. Cl. CPC G06F 17/30277; G06K 9/00671; G06F 17/30256; G06F 17/30274; G06F 17/30882; G06F 21/6218; G06F 17/3028

(57) ABSTRACT

A system and method in a mobile device for providing digital content through an object includes receiving a first image of the object; processing the first image to identify at least a first image attribute; accessing a database of registered objects, each registered object being identified by a linked image and being associated with metadata describing the object; retrieving from the database of registered objects a first registered object having a linked image matching the first image attribute; in response to the retrieving, providing a user interface configured to interact with the first registered object; receiving using the user interface, a digital content; assigning the digital content to the first registered object; designating one or more recipients of the digital content; and storing linking data for the first registered object in the database of registered objects, the linking data associating the digital content to the first registered object.

### CROSS REFERENCE TO RELATED APPLICATIONS

This application claims priority to U.S. Provisional Patent Application No. 62/634,676, entitled SYSTEM AND METHOD FOR PROVIDING DIGITAL CONTENT ASSOCIATION WITH AN OBJECT, filed Feb. 23, 2018, which is incorporated herein by reference for all purposes.

### FIELD

The present disclosure relates to a system and a method for providing digital content association with an object and, in particular, to a system and method for attaching digital content to objects that does not have network connection capabilities and transmitting the digital content to recipients.

### BACKGROUND

In today's digital environments, users can only connect and execute commands on connected devices, such as cellphones, tablets, and computers. That is, users can only connect and execute commands on devices that are connected to a data network, such as a cellular data network or a Wi-Fi data network or other types of data communication network.

Unconnected or offline devices—that is, objects that do not have the capability to be connected to a data network—are not capable of interacting with the digital world. User operation of these objects is often defined by the physical functions provided by each device. For example, a water bottle can only hold fluid or small objects inside the bottle. There are no additional functions the water bottle can execute.

### SUMMARY

The present disclosure discloses a device and method for providing digital content association with an object, substantially as shown in and/or described below, for example in connection with at least one of the figures, as set forth more completely in the claims.

These and other advantages, aspects and novel features of the present disclosure, as well as details of an illustrated embodiment thereof, will be more fully understood from the following description and drawings.

In embodiments of the present disclosure, a method for providing digital content through an object includes receiving, at a first mobile device, a first image of the object; processing, at the first mobile device, the first image to identify at least a first image attribute, the first image attribute including an image feature or an image object; accessing, by the first mobile device, a database of registered objects, each registered object being identified by a linked image and being associated with metadata describing the object; retrieving from the database of registered objects a first registered object having a linked image matching the first image attribute; in response to the retrieving, providing, at the first mobile device, a user interface configured to interact with the first registered object; receiving, at the first mobile device using the user interface, a digital content; assigning, at the first mobile device using the user interface, the digital content to the first registered object; designating, at the first mobile device using the user interface, one or more recipients of the digital content; and storing linking data for the first registered object in the database of registered objects, the linking data associating the digital content to the first registered object.

In other embodiments, a system in a mobile device for providing digital content through objects includes an imaging sensing device configured to receive an image; a processor; a communication interface; a display; and a memory coupled with the processor, wherein the memory is configured to provide the processor with instructions which when executed cause the processor to: receive a first image of the object; process the first image to identify at least a first image attribute, the first image attribute including an image feature or an image object; access a database of registered objects, each registered object being identified by a linked image and being associated with metadata describing the object; retrieve from the database of registered objects a first registered object having a linked image matching the first image attribute; in response to the retrieving, provide a user interface configured to interact with the first registered object; receive, using the user interface, a digital content; assign, using the user interface, the digital content to the first registered object; designate, using the user interface, one or more recipients of the digital content; and store in the database of registered objects linking data for the first registered object, the linking data associating the digital content to the first registered object.

### BRIEF DESCRIPTION OF THE DRAWINGS

Various embodiments of the present disclosure are disclosed in the following detailed description and the accompanying drawings.

FIG. 1 illustrates an environment in which the advanced user interaction system is implemented in one example.

FIG. 2 illustrates an environment in which the advanced user interaction system is implemented in another example.

FIG. 3 illustrates an environment in which the advanced user interaction system is implemented in another example.

FIG. 4 is a schematic diagram of a mobile device in which the advanced user interaction system can be implemented in some examples.

FIG. 5 is a flowchart illustrating a method to on-board an object in some embodiments.

FIG. 6 is a flowchart illustrating a method to retrieve an object in some embodiments.

FIG. 7 is a flowchart illustrating a method for attaching a digital content in some embodiments.

FIG. 8 is a flowchart illustrating a method for receiving a digital content in some embodiments.

FIG. 9, which includes FIGS. 9(a) and 9(b), illustrates an example application of the advanced user interaction system in some embodiments.

FIG. 10 illustrates an example application of the advanced user interaction system in alternate embodiments.

FIG. 11 illustrates an example application of the advanced user interaction system in alternate embodiments.

### DETAILED DESCRIPTION

The present disclosure can be implemented in numerous ways, including as a process; an apparatus; a system; a composition of matter; a computer program product embodied on a computer readable storage medium; and/or a processor, such as a hardware processor or a processor device configured to execute instructions stored on and/or provided by a memory coupled to the processor. In this specification, these implementations, or any other form that the present disclosure may take, may be referred to as techniques. In general, the order of the steps of disclosed processes may be altered within the scope of the present disclosure. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the present disclosure is provided below along with accompanying figures that illustrate the principles of the present disclosure. The present disclosure is described in connection with such embodiments, but the present disclosure is not limited to any embodiment. The scope of the present disclosure is limited only by the claims and the present disclosure encompasses numerous alternatives, modifications and equivalents. Numerous specific details are set forth in the following description in order to provide a thorough understanding of the present disclosure. These details are provided for the purpose of example and the present disclosure may be practiced according to the claims without some or all of these specific details. For the purpose of clarity, technical material that is known in the technical fields related to the present disclosure has not been described in detail so that the present disclosure is not unnecessarily obscured.

According to embodiments of the present disclosure, an advanced user interaction system and method implemented in a mobile device processes an image to identify an object and enables a digital content to be attached to the object or to be received from the object. The advanced user interaction system and method enables the digital content to be designated for specific recipients or for all recipients. In this manner, the advanced user interaction system of the present disclosure enables any objects to function as a carrier of digital content whereby the digital content can be created by the sender and transmitted to the recipients simply by scanning an image of the object.

In embodiments of the present disclosure, the advanced user interaction system allows users to convey digital content through any objects, including connected electronic devices or unconnected (or offline) devices or objects. The advanced user interaction system captures and recognizes objects by their visual features and on-boards the objects into the digital world so that the objects can be connected with human and/or other objects. In other words, the advanced user interaction system converts an unconnected “dumb object” to a connected “smart device” so that a user can attach and receive a variety of digital content through the object. In some embodiments, the digital content can include text messages, voice messages, video messages, bitcoins, food delivery services, coupons, business cards, and other types of digital contents. The system can also be applied to connected devices, such as a smart television (TV) or a game console, for the purpose of adding additional functional features to the connected device. For example, the advanced user interaction system can be used to add parental control functions to a smart television.

In the present description, an “object” refers to a thing, an article, an item, or a device that may or may not have the capability to be connected to a data network. In some examples, the object can be an everyday item, such as a water bottle, a bicycle, a cup, a picture, a remote control, and a kitchen appliance. In other examples, the object can be a human face, a hand gesture (e.g. thumbs up), or a number. As further examples, the object can be any animated object (e.g. a dog or a cat) or any inanimate object (e.g. a cup or a book). Alternately, the object can be a connected device that has the capability to be connected to a data network, such as a mobile phone, a tablet, a smart television or a game console. In the following description, an object that does not have the capability to be connected to a data network is sometimes referred to as an unconnected or offline device or object. An unconnected or offline device can also refer to a connected device that is currently not set up to be connected to a data network.

In embodiments of the present disclosure, the advanced user interaction system is implemented in a mobile device, such as a smart phone. The advanced user interaction system implements a computer vision sub-system in the mobile device to facilitate the image capture and processing operations. In some embodiments, the advanced user interaction system combines computer vision (CV), machine learning (ML) and advanced user interaction to enable a user, using the mobile device, to send and receive messages from almost any objects as long as images of the objects can be captured, and the objects can be recognized by the computer vision and machine learning algorithms. The objects that are used as carrier of digital content can take any form or shape as long as the objects can be recognized by the computer vision sub-system implemented in the mobile device.

The advanced user interaction system of the present disclosure implements many advantageous features. First, the advanced user interaction system incorporates a computer vision sub-system including a digital camera and implementing computer vision and machine learning algorithms. The computer vision sub-system facilitates the object on-boarding process using the digital camera and supported by computer vision. The object can be a connected device or an unconnected object. Furthermore, the object can take on any form or shape, as described above. The computer vision sub-system further enables retrieving of an on-boarded object from a database of on-boarded objects using the camera and computer vision. In some cases, the computer vision sub-system may be configured to relate the on-boarded item to another object.

In the present description, “on-boarding” refers to the process of adding an object to a user's digital environment. In one example, on-boarding refers to the process of adding a device or an object to a set of registered devices or objects being controlled by or in communication with the user through the user's digital communication device, such as a smart phone. As used herein, on-boarding an object refers to registering and storing the object into a database of registered objects where the database is assessed by the user's mobile device to retrieve registered objects.

Second, using the advanced user interaction system of the present disclosure, a user can on-board any object (which can be connected or unconnected devices) and turn the object into a smart device. After on-boarding the object, the user can interact with the object, such as through an application (App) executed on a connected electronic device, such as a mobile device. Furthermore, any kind of interface can be associated with the on-boarded object. In some cases, the advanced user interaction system can be used to add new features to connected devices, such as adding parental control to a smart television.

Third, the advanced user interaction system of the present disclosure also enables new business paradigms. For example, the advanced user interaction system can be implemented to provide an interface to enable a business entity to send messages to its customer base. The advanced user interaction system can be implemented to allow services to be attached to an object. In yet another example, the advanced user interaction system can be used to limit the functions of a connected device by the owner of the connected device. In another example, access control can be added to any connected device to limit the functions or services provided through the use of the advanced user interaction system of the present disclosure.

In some examples, the advanced user interaction system of the present disclosure can be used to enable the following functions for any objects, connected or unconnected.

(1) Sending a message from one user to another, or from the manufacturer to the end consumer.

(2) Sending an advertisement from the manufacturer to an end consumer.

(3) Providing an entry point to a wide range of offerings including services, social network, coupons, money transfer, gifts, or delivery.

(4) Providing a user the ability to block service on a particular device.

The advanced user interaction system of the present disclosure realizes many advantages. First, the advanced user interaction system enables a user to connect an offline object to the digital world. Second, the advanced user interaction system enables a user to add services (e.g. message, coupons, action such as food delivery) to an unconnected object. Third, the advanced user interaction system enables a user to receive services (e.g. message, coupons, action such as food delivery) from an unconnected object. Fourth, the advanced user interaction system enables a user to control an online device by adding a digital content that contains command to the device. Finally, the advanced user interaction system provides a simple way for businesses to reach its consumer after purchase of products.

Operation Overview

The advanced user interaction system of the present disclosure is implemented by a user first on-boarding an object and then retrieving the on-boarded object, by the same user or by a different user. Digital content can be attached to and received from the object.

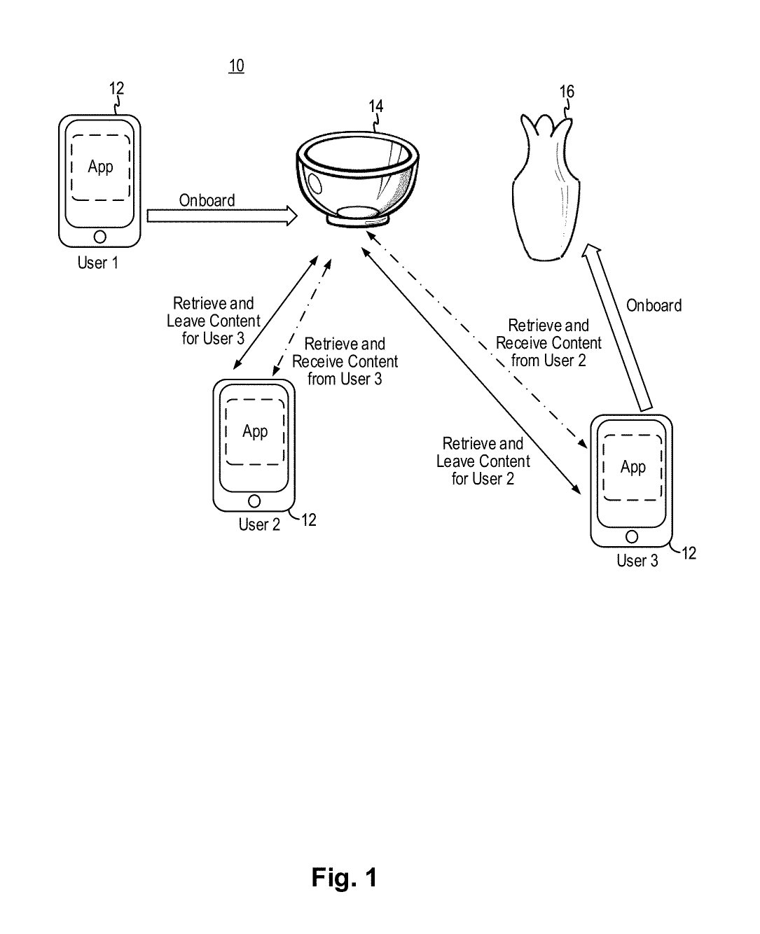

FIG. 1 illustrates an environment in which the advanced user interaction system is implemented in one example. Referring to FIG. 1, an environment 10 includes objects (such as a bowl 14 and a vase 16) and Users 1-3 each operating his/her own respective mobile device 12. Users 1-3 are part of a digital environment, such as the users may share the same family account in the digital environment or the users may each have his/her own account, but the accounts are linked or grouped together in the digital environment. User 1, using an application associated with the advanced user interaction system of the present disclosure and executed on User 1's associated mobile device, on-boards an object 14, such as a bowl, into the digital environment associated with the users. User 1 may further set up the permission that controls which user or user group can retrieve the object 14. In the present example, User 1 grants access permissions to both User 2 and User 3. Meanwhile, User 3, using the application associated with the advanced user interaction system of the present disclosure and executed on User 3's associated mobile device, on-boards another object 16, such as a vase, into the digital environment associated with the users. User 3 also set up the permission level for object 16. In the present example, User 3 grants access permissions to both User 1 and User 2.

With objects thus on-boarded, Users 1-3 may use the objects to transmit digital content. It is instructive to note that the bowl or the vase by itself is not capable of providing any digital data functionality as they are merely inanimate objects not provided with any connectivity capability. However, with the use of the advanced user interaction system, these objects can now “store” and “transmit” digital content.

For example, User 2 retrieves the object 14 by scanning the bowl with the App using her mobile device 12. With object 14 retrieved, User 2 leaves a message and attaches the message to object 14. User 2 also sets up the permission level that only User 3 can receive the message. At a later time, User 3 retrieves the object 14 by scanning the bowl with the App using her mobile device 12. User 3 then receives the message that User 2 has created. Subsequently, User 3 can also leave a message for User 2 using object 14. User 2 receives the message by scanning the bowl. For example, the messages may be displayed on the App on User 2 and User 3's mobile devices.

FIG. 1 illustrates the example where one user uses an object to transmit digital content to another user. That is, the advanced user interaction system is used in a one-to-one digital content exchange. The advanced user interaction system of the present disclosure can also be used to provide one-to-many digital content exchange or many-to-one digital content exchange.

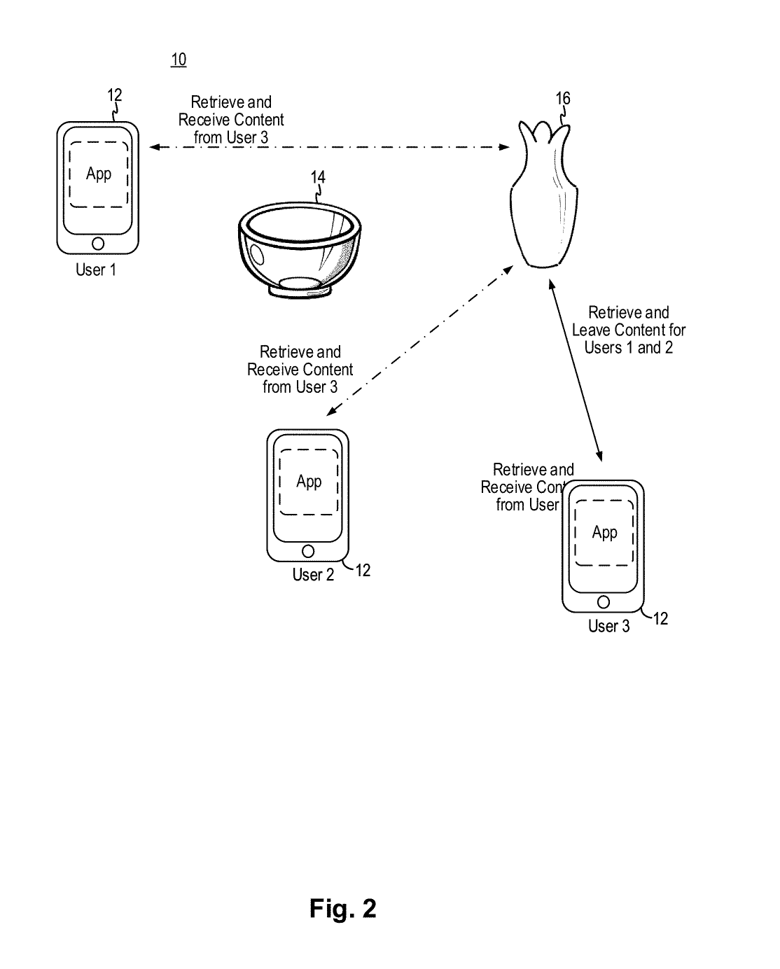

FIG. 2 illustrates an environment in which the advanced user interaction system is implemented in another example. In particular, FIG. 2 illustrates an example of one-to-many digital content exchange using the advanced user interaction system of the present disclosure. Referring to FIG. 2, User 3 retrieves the object 16 by scanning the vase with the App using her mobile device 12. With object 16 retrieved, User 3 leaves a message and attaches the message to object 16. User 3 also sets up the permission level that both User 1 and User 2 can receive the message.

At a later time, User 1 retrieves the object 16 by scanning the vase with the App using her mobile device 12. User 1 then receives the message that User 3 has created. For example, the message may be displayed on the App on User l's mobile device. Similarly, at a given time, User 2 retrieves the object 16 by scanning the vase with the App using her mobile device 12. User 2 then receives the message that User 3 has created. For example, the message may be displayed on the App on User 2's mobile device.

In the one-to-many digital content exchange, the user can set the permission level to allow all the users in the associated digital environment to receive the message. The message is thus a broadcast message to all users. Alternately, the user can set the permission level to allow some of the users in the associated digital environment to receive the message. The message is thus a multicast message to the designated users.

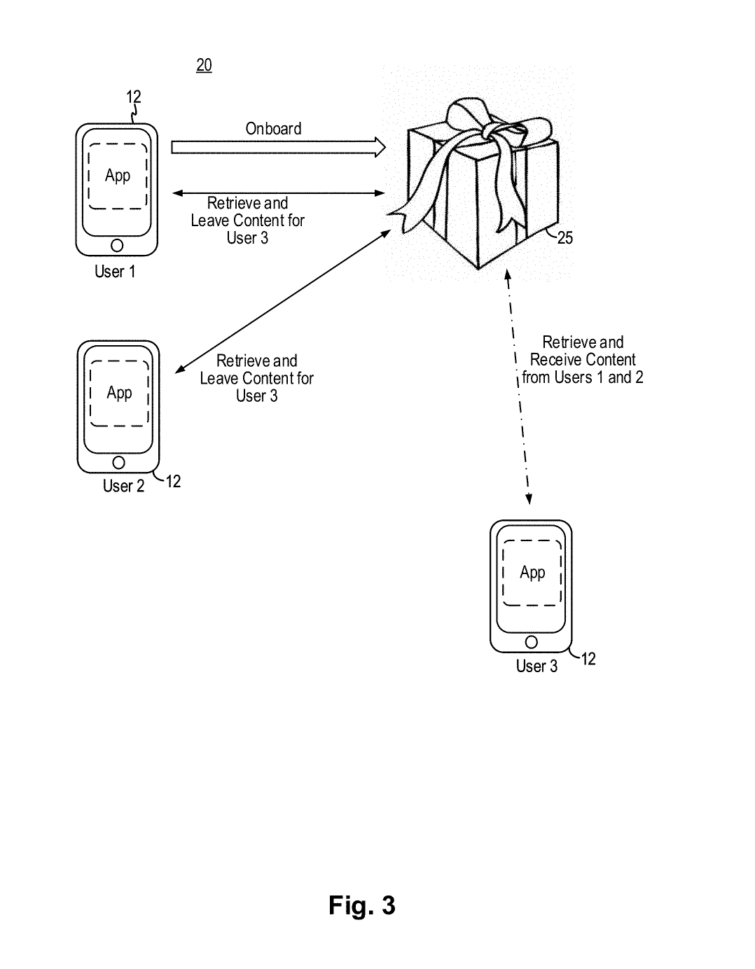

FIG. 3 illustrates an environment in which the advanced user interaction system is implemented in another example. In particular, FIG. 3 illustrates an example of many-to-many digital content exchange using the advanced user interaction system of the present disclosure. Referring to FIG. 2, in an environment 20, Users 1 and 2 wish to leave a birthday wishes message on a present 25 for User 3. In that case, User 1 (or User 2) on-boards the object 25 into her digital environment. User 1 retrieves the object 25 by scanning the present with the App using her mobile device 12. With object 25 retrieved, User 1 leaves a message and attaches the message to object 25. User 1 also sets up the permission level that User 3 can receive the message. At another time, User 2 retrieves the object 25 by scanning the present with the App using her mobile device 12. With object 25 retrieved, User 2 leaves a message and attaches the message to object 25. User 2 also sets up the permission level that User 3 can receive the message.

At a later time, User 3 retrieves the object 25 by scanning the present with the App using her mobile device 12. User 3 then receives the messages that User 1 and User 2 have created and attached to the present 25. For example, the messages may be displayed on the App on User 3's mobile device sequentially.

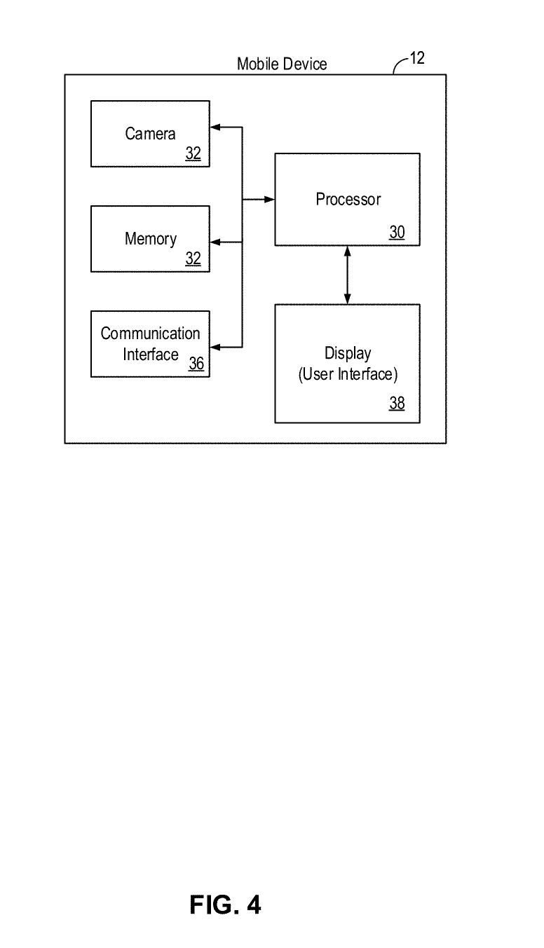

FIG. 4 is a schematic diagram of a mobile device in which the advanced user interaction system can be implemented in some examples. Referring to FIG. 4, a mobile device 12 includes a digital camera 32 for capturing a digital image, a memory 34 for storing data, a communication interface 36 for supporting cellular and/or wireless communication, and a display 38 providing the user interface. The mobile device 12 includes a processor 30, which can be a micro-controller or a micro-processor, for controlling the operation of the mobile device. In some embodiments, the processor 30 may implement a computer vision sub-system.

On-Boarding Method for Objects

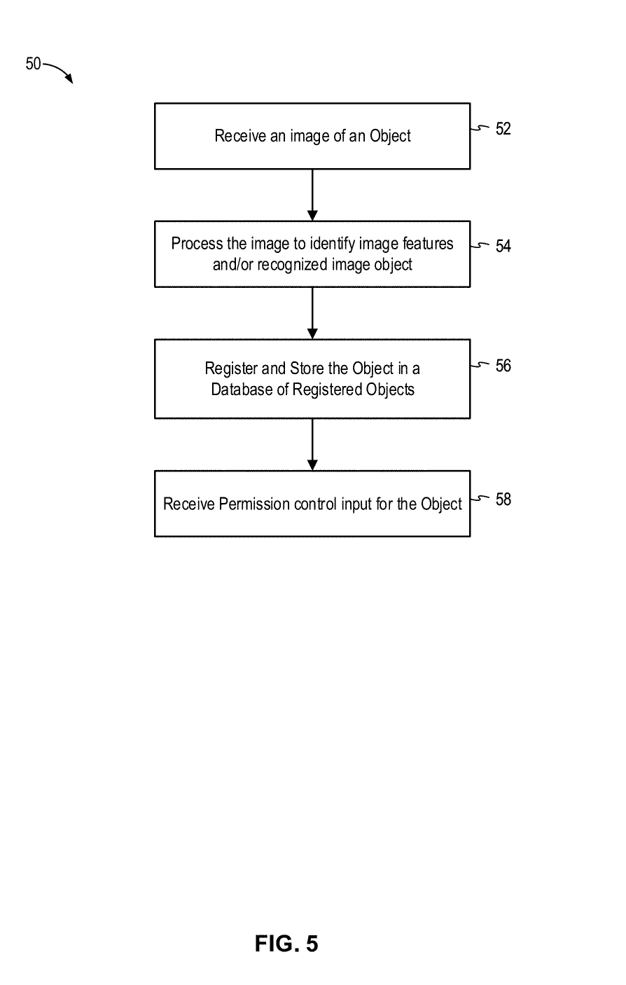

FIG. 5 is a flowchart illustrating a method to on-board an object in some embodiments. Referring to FIG. 5, an object on-boarding method 50 may be implemented in a mobile device and executed by the App on the mobile device in embodiments of the present disclosure. At step 52, the method 50 initiates the App and detects an image in the camera field of view where the image contains the object to be on-boarded. It is instructive to note that the on-boarding method does not necessarily require the camera to capture or snap the image. In some embodiments, it is only necessary that an image is present in the camera field of view.

At step 54, the method 50 processes the image to identify image features and/or a recognized image object. In one embodiment, the computer vision sub-system in the processor of the mobile device may be initiated to scan the image content in the camera field of view (FOV). The computer vision sub-system extracts image features from the field of view, which can be used as a unique representation of the connected device and the device's surrounding environment. In some embodiments, the computer vision sub-system may also run a vision-based object recognition method to recognize the connected device to be on-boarded. In the present description, image features refer to derived values that are informative and descriptive of the image, such as edges and contours in the digital image. In the present description, image objects refer to instances of semantic objects in the digital image, such as a vase, a lamp or a human. In the following description, the term “image attributes” is sometimes used to refer collectively to image features or image object of an image.

At step 56, the method 50 registers the object and stores the object in the database of registered objects. In the present description, registering an object refers to adding or entering the device into the advanced user interaction system of the present disclosure using information provided about the object. In particular, the object is stored in the database identified by the image features or recognized image object as the linked image. The object may also be stored with associated metadata in the database. For example, the metadata may include the name or an identifier of the object.

At step 58, the method 50 receives permission control input for the object and stores the permission level assigned to the object in the database. In particular, the permission control determines which user can subsequently retrieve the on-boarded object. In one example, the permission control can be used to assign one of the following permission levels: (i) only the user who on-boards the object can retrieve the object, (ii) only another user (not the user who on-boarded the object) can retrieve the object, (iii) only a group of designated users can retrieve the object, and (iv) all users can retrieve the object.

In embodiments of the present disclosure, the database of registered objects may be stored in the mobile device. Alternately, the database may be stored in a remote server, such as a cloud server, and the mobile device accesses the cloud server to access the database.

Using the object on-boarding method 50, one or more objects may be on-boarded or registered with the advanced user interaction system and be associated with the digital environment of particular users.

In some embodiments, the advanced user interaction system attaches the digital content to a particular object by discriminating each individual object and allowing a user to attach/receive digital content to/from a particular individual object. For example, if the system attaches a message to a banana as the object in a living room, another banana in a bedroom does not have the same message attached.

In some embodiments, the computer vision sub-system in the processor of the mobile device not only identifies the object in the foreground, but also identifies the surrounding environment (background) where the object is adjacent to and/or a geographical location that the object is situated. The advanced user interaction system may determine the geographical location using various means, including, but not limited to, using a Global Navigation Satellite system (GNSS), Bluetooth, and Wi-Fi. A similar object may have a different background when placed in different environments. When two similar objects are on boarded, the advanced user interaction system may distinguish between the two similar objects using background or geographic location information.

In one embodiment, the object on-boarding method may prompt the user to select different ways for the system to recognize objects. For example, the system may prompt the use to select: (1) to recognize the object only, or (2) to recognize the object and its environment.

In the event the user selects option (1), the object on-boarding method implements object-based recognition, where the object on-boarding method does not differentiate between similar objects placed in different locations. In the event the user selects option (2), the object on-boarding method implements object and environment-based recognition, where the object on-boarding method recognizes the difference between similar objects placed in different locations.

Object Retrieval Method

With objects on-boarded, the advanced user interaction system may be deployed to enable digital content exchange between users. The object retrieval method is executed when the user wants to attach or receive digital content after the on-boarding process. In some embodiments, users retrieve the object and operate the object through the user interface provided by the application on their respective mobile device. Depending on the permission control setup during the on-boarding process, a user may or may not have access to a particular on-boarded object.

For example, the on-boarding process can be executed by a user and the permission control is set up so that the object can only be retrieved by the same user. In another example, the on-boarding process can be executed by a user and the permission control is set up so that the object can only be retrieved by another specified user. In yet another embodiment, the on-boarding process can be executed by a user and the permission control is set up so that the object can be retrieved by a group of users.

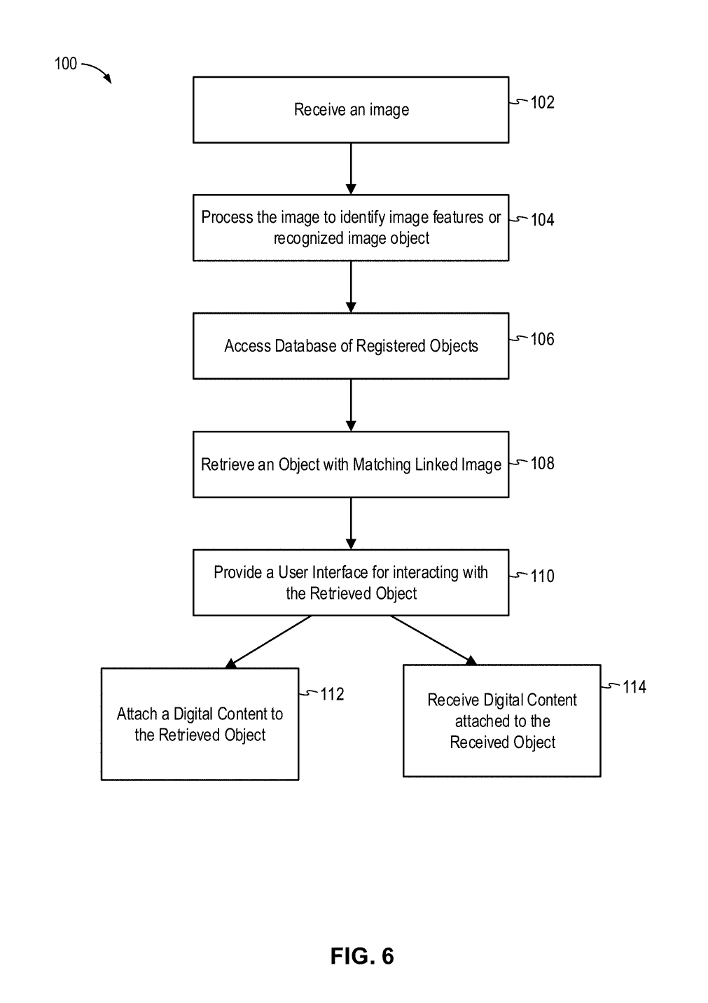

FIG. 6 is a flowchart illustrating a method to retrieve an object in some embodiments. Referring to FIG. 6, an object retrieval method 100 may be implemented in a mobile device and executed by the App in embodiments of the present disclosure.

At step 102, the method 100 initiates the App and detects an image in the camera field of view. The image may contain the object. It is instructive to note that the retrieval method does not necessarily require the camera to capture or snap the image. In some embodiments, it is only necessary that an image is present in the camera field of view.

At step 104, the method 100 processes the image to identify the image attributes of the image, that is, to identify the image features and/or a recognized image object in the image. In one embodiment, the computer vision sub-system in the processor of the mobile device may be initiated to scan the image content in the camera field of view. The computer vision sub-system extracts image features from the field of view. In some embodiments, the computer vision sub-system may also run a vision-based object recognition method to recognize an image object.

At step 106, the method 100 accesses the database of registered objects. At 108, the method 100 retrieves an object with the matching linked image. For example, the method 100 may compare the extracted image features or recognized image object with linked images in the database. The compare operation can be performed on the mobile device, such as when the database is stored on the mobile device. The compare operation can also be performed on the cloud server in the cases where the database is stored at the cloud server.

At step 110, with the object retrieved, the method 100 provides a user interface designated for interacting with the retrieved object. In one embodiment, the user interface may be provided on the display of the mobile device. In the present embodiment, the user interface may provide an option to attach a digital content to the retrieved object (step 112). The user interface may also provide an option to receive digital content that may be attached to the retrieved object (step 114).

Attaching Digital Content

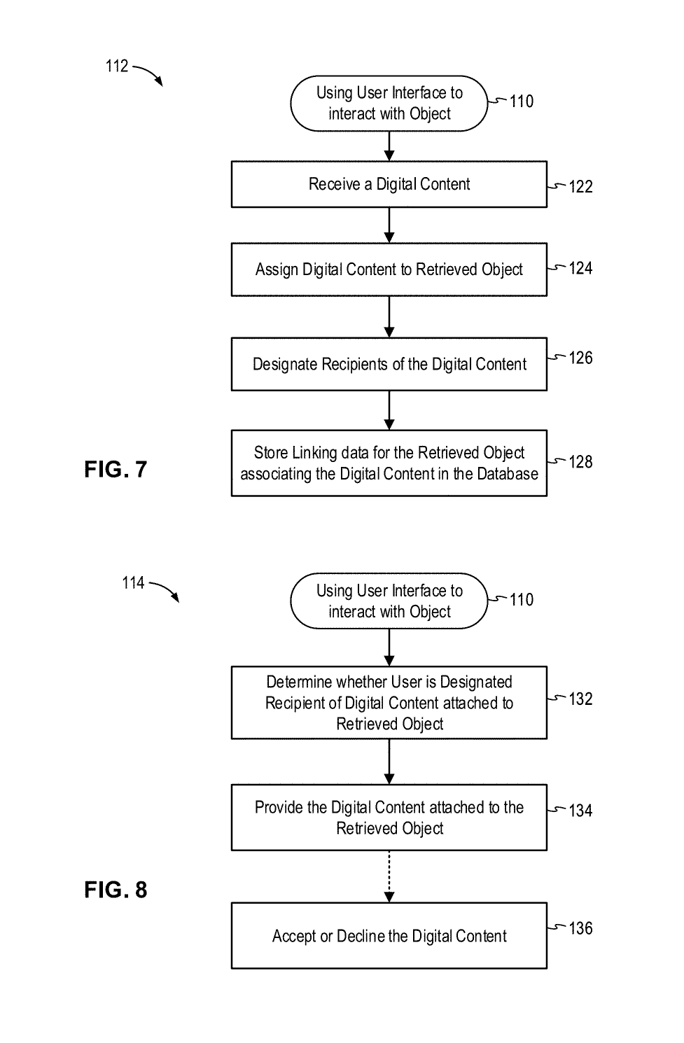

In the event the user selects to attach a digital content to the retrieved object, the digital content attach method of FIG. 7 may be executed. FIG. 7 is a flowchart illustrating a method for attaching a digital content in some embodiments.

Referring to FIG. 7, a digital content attach method 112 may be implemented in a mobile device and executed by the App in embodiments of the present disclosure.

At step 110, after the object is retrieved, the user interface to interact with the retrieved is presented. In some embodiments, the user interface may provide options for various ways the user may interact with the retrieved object. In one example, the user interface may provide the user with selections to create a message, to create a gift card, to create a food delivery order, to create parental control on the object, or to create other operational control on the object.

In some embodiments, an unconnected object or device can only be used as a carrier to convey digital content. An unconnected object or device cannot be changed or controlled by the digital content. On the other hand, a connected device can be controlled or changed by the digital content. For example, a smart TV can be locked by a digital content that carries a TV lock command for parental control purpose.

At step 122, the method 112 receives a digital content created by the user. At 124, in response to user input, the method 112 assigns the digital content to the retrieved object. At 126, in response to user input, the method 112 designates recipients of the digital content. At 128, the method 112 stores linking data for the retrieved object in the database where the linking data associates the digital content to the retrieved object.

In embodiments of the present disclosure, the digital content is stored in a content database or a content server, apart from the database of registered objects. In that case, the method 112 stores, in the database of registered objects, in the metadata of the retrieved object or the data structure of the retrieved object a content link to a location in the content server at which the digital content is stored. The content link can be used to retrieve, update, modify and delete the digital content. In the event that the object is retrieved later by a user to receive the digital content, the App on the mobile device accesses the data structure of the object and then obtains the content link attached to the object. The App then parses the content link and acquires the digital content from the content server.

In some embodiments, multiple digital content may be attached to an object and multiple links may be attached to the metadata or data structure of the object.

In other embodiments, the method 112 may further receives input data describing the properties of the digital content created. For example, the user may specify a duration for the digital content, or an expiration date or time. The user may also specify the exclusive or inclusive nature of the digital content. That is, the user may specify whether the digital content is designated for specific users (exclusive) or all users (inclusive)

Receiving Digital Content

In the event the user selects to receive a digital content to the retrieved object, the digital content receive method of FIG. 8 may be executed. FIG. 8 is a flowchart illustrating a method for receiving a digital content in some embodiments.

Referring to FIG. 8, a digital content receive method 114 may be implemented in a mobile device and executed by the App in embodiments of the present disclosure.

At step 110, after the object is retrieved, the user interface to interact with the retrieved is presented. At step 132, the method 114 determines whether the user is a designated recipient of the digital content attached to the retrieved object.

At 134, in the event that the user is determined to be a designated recipient, the method 114 provides the digital content attached to the retrieved object. In one example, the digital content may be displayed on the App on the mobile device.

In the event there are multiple contents associated with the retrieved object, during the retrieving process, the App will display all of the digital contents, such as in the form of icons, on the display of the mobile device and the user may select the digital content she desires to view. In response to the user selecting a particular digital content, the method 114 will provide the selected digital content.

In the event that the digital content is stored in the content server, the method 114 obtains the content link and requests the actual content using the content link stored in the metadata or data structure of the retrieved object. In other words, the method 114 requires the digital content from the content server using the content link.

In response to receiving the digital content, the user may take different action depending on the nature of the digital content. In some embodiments, at step 136, the method 114 may provide the user with an option to accept or decline the digital content. Step 136 is optional and may be omitted in some embodiments of the present disclosure.

For example, the digital content may be a gift card and the user may accept the gift card and save the gift card into her own store account. In another example, the digital content may be a video message and the user may select to view the video. In yet another embodiment, the digital content may be a command to control a connected device and the user receiving the content results in executing the command at the connected device.

After the digital content is provided to the user, the digital content may persist or may be deleted, depending on the properties of the digital content provided by the creator. In embodiments of the present disclosure, the digital content may or may not be deleted from the object depending on the property of the digital content. If the property of the digital content is exclusive, such as Bitcoin, or gift card, the content will be deleted once the receiver receives the content. If the digital content is a designed as a short time message, it will be deleted after the time duration is up after the receiver receives the message, or the message may be deleted anyway no matter whether the receiver receives it or not. If the digital content is inclusive, such as a message for the public, the content will not be deleted after being received by one receiver.

Multiple Objects within a Scene

In embodiments of the present disclosure, the advanced user interaction system may capture multiple objects at the same time within the camera field of view, either during the on-boarding process or during the retrieval process. In some embodiments, the on-boarding method or the retrieval method will query the user to select an area within the field of view for the computer vision system to focus on. The on-boarding or retrieval method then continues by processing the image in the selected area for visual features or image object.

Computer Vision and Machine Learning

In embodiments of the present disclosure, for the purpose of vision-based onboarding and retrieving process, the image processing operation leverage computer vision and machine learning to identify image features and recognize image object. In some embodiments, various feature extraction methods can be applied, such as Scale-Invariant Feature Transform (SIFT), Speeded-Up Robust Features (SURF), Histogram of oriented gradients (HOG), as well as deep neural network flavor of feature extractors, such as VGGnet, ResNet, etc. In other embodiments, various object recognition methods can be applied, such as Bag of World based classification, as well as deep neural network flavor of object recognition, such as fast-RNN, MobileNet, and Yolo.

Application Examples

The advanced user interaction system and method of the present disclosure can be applied to convey digital content through any object—whether a connected device or an unconnected device or object. In the present description, the term “digital content” refers to contents that can be represented by digital data. Examples of digital content includes, but are not limited to, text messages, voice messages, video messages, bitcoins, food delivery services, coupons, business cards, an advertisement, a service offering and command signals to add additional control features to connected electronic devices. For example, a digital content can include a command signal for controlling a connected device. In one example, the digital content can include a comment signal to lock a television or game console to prevent it from being turned on. In this manner, the digital content is used to implement parental control.

Example applications are described below to illustrate the various ways the advanced user interaction system and method of the present disclosure can be applied to convey digital content.

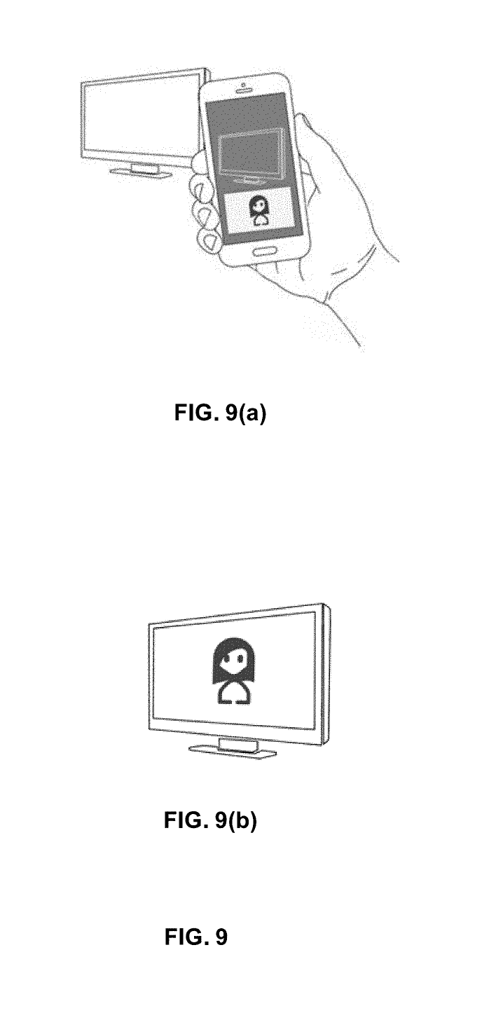

FIG. 9, which includes FIGS. 9(a) and 9(b), illustrates an example application of the advanced user interaction system in some embodiments. The example application shown in FIG. 9 illustrates using the advanced user interaction system to add life to inanimate objects. With a pre-onboarded object, a user can add new digital content (pictures/voice mail/text message/video message) to the object.

In the present example, User A on-boards a new connected device Entity C, which is a television, at some point in time. Referring to FIG. 9(a), at a later time, User A launches the App on her mobile device and points at Entity C (the television). The system retrieves Entity C and provides a user interface to User A. Using the App on the mobile device, User A creates a digital content to be attached to Entity C. For example, User A may record a video message for the Child: “Don't forget to finish your homework and then you can watch the TV for 30 minutes.” The video message thus created is attached to Entity C.

The attached digital content can be retrieved as follows. In a first case, Child comes home at a later time. Child launches the App on his mobile device and points at Entity C (the television). The App retrieves Entity C and provides the digital content to Child. In this case, the video message attached to Entity C may be played on Entity C—that is the video message may be played on the television, as shown in FIG. 9(b).

In a second case, Child comes home at a later time. Child turns on the television, the video message attached to the television will automatically plays before TV program starts. The second case is implemented by the virtue of both the television and the mobile device being connected devices. When the TV is turned ON, the TV pulls the latest updates from object database. When a digital content is found to be attached to the TV, the TV executes the commands and displays the video message on the TV, as shown in FIG. 9(b).

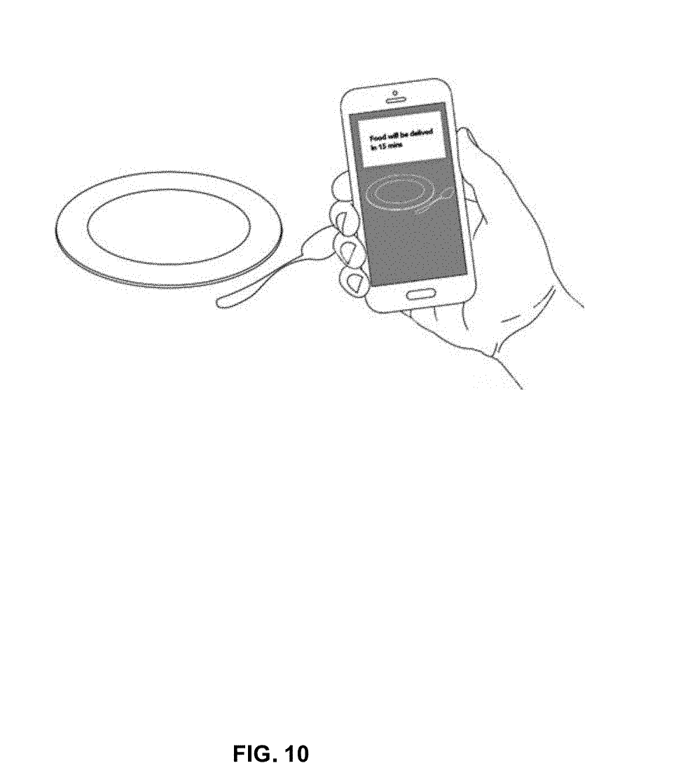

FIG. 10 illustrates an example application of the advanced user interaction system in alternate embodiments. The example application shown in FIG. 10 illustrates using the advanced user interaction system to send a gift. With a pre-onboarded object, a user can gift a digital or physical good to another person. The physical good can be gifted through an on-line retail site, such as Amazon.com.

In the present example, User A on-boards a new object—Entity D, which is a book or a dinner plate, at some point in time. At a later time, User A launches the App on her mobile device and points at Entity D. The system retrieves Entity D and provides a user interface to User A. Using the App on the mobile device, User A creates a digital content to be attached to Entity D. For example, User A may add digital goods, such as ebooks, gift cards, coupons, digital money—Red Envelope during Chinese New Year, games, movies, music, as the digital content. User A may also add physical goods, such as food, fruits, books delivery from an online retail site, as the digital content. Finally, User A may also add services, such as food delivery, dry clean laundry service, maid cleaning service, or handy man service, as the digital content. The digital content is attached to Entity D.

The attached digital content can be retrieved as follows. User B launches the App on her mobile device and scans Entity D. The App retrieves Entity D and provides the attached digital content to User B. At this point, User B can have several options:

In the case the digital content is a digital goods, User B can accept or decline the offer. In the case the digital content is physical goods, User B can accept or decline the offer. In the case the digital content is a service, User B can accept or decline the offer. When an offer is accepted, the service provider will initiate the service. For example, as shown in FIG. 10, User B accepts the food delivery service and the App display the food service driving to the service location.

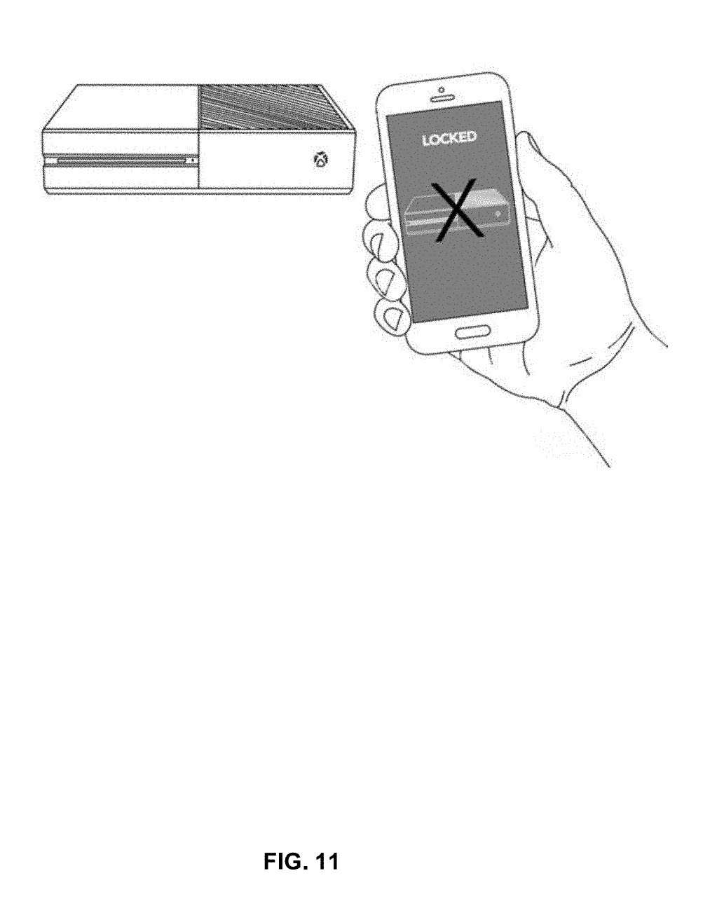

FIG. 11 illustrates an example application of the advanced user interaction system in alternate embodiments. The example application shown in FIG. 11 illustrates using the advanced user interaction system to implement parental control. With a pre-onboarded object, a user can add additional control features onto the object. Typically, the objects are connected devices.

In some examples, the objects for implementing parental control can include a television, a computer, a gaming console, an oven, a bedroom lock, a stove, or a safety box. In the present example, User A on-boards a connected device Entity J, which is a gaming console at some point in time. At a later time, User A launches the App on her mobile device and points at Entity J (the gaming console). The system retrieves Entity J and provides a user interface to User A. Using the App on the mobile device, User A locks Entity J remotely, as shown in FIG. 11.

If a visitor or User A's child wants to access Entity J, that user would have to launch the App and seek approval to unlock the device. User A can remotely grant or reject access request.

The above detailed descriptions are provided to illustrate specific embodiments of the present disclosure and are not intended to be limiting. Numerous modifications and variations within the scope of the present disclosure are possible. The present disclosure is defined by the appended claims.

What is claimed is:

1. A method for providing digital content through an object, comprising:
receiving, at a first mobile device, a first image of the object;
processing, at the first mobile device, the first image to identify at least a first image attribute, the first image attribute comprising an image feature or an image object;
accessing, by the first mobile device, a database of registered objects, each registered object being identified by a linked image and being associated with metadata describing the object;
retrieving from the database of registered objects a first registered object having a linked image matching the first image attribute;
in response to the retrieving, providing, at the first mobile device, a user interface configured to interact with the first registered object;
receiving, at the first mobile device using the user interface, a digital content;
assigning, at the first mobile device using the user interface, the digital content to the first registered object;
designating, at the first mobile device using the user interface, one or more recipients of the digital content; and
storing linking data for the first registered object in the database of registered objects, the linking data associating the digital content to the first registered object.

2. The method of claim 1, further comprising:
receiving, at a second mobile device, a second image;
processing, at the second mobile device, the second image to identify at least a second image attribute, the second image attribute comprising an image feature or an image object;
accessing, by the second mobile device, the database of registered objects;
retrieving from the database of registered objects the first registered object having the linked image matching the second image attribute;
in response to the retrieving, providing, at the second mobile device, the user interface configured to interact with the first registered object;
determining whether the second mobile device is a designated recipient of the digital content attached to the first registered object; and
in response to the determining that the second mobile device is a designated recipient, providing, at the second mobile device, the digital content associated with the first registered object.

3. The method of claim 1, wherein receiving, at the first mobile device, the first image of the object comprises:
activating, at the first mobile device, an application; and
receiving, at the application on the first mobile device, the first image.

4. The method of claim 2, wherein receiving, at the second mobile device, the second image comprises:
activating, at the second mobile device, the application; and
receiving, at the application on the second mobile device, the second image.

5. The method of claim 1, wherein the object comprises an object without the capability to be connected to a data network or an object with the capability to be connected to a data network.

6. The method of claim 2, wherein storing in the database of registered objects linking data for the first registered object comprises:
storing the digital content in a content server; and
storing, in the database of registered objects, in the metadata of the first registered object a link to a location in the content server at which the digital content is stored.

7. The method of claim 6, wherein in response to providing the user interface, providing, at the second mobile device, the digital content associated with the first registered object comprises:
retrieving, from the database of registered objects, the link to the digital content associated with the first registered object;
accessing, using the second mobile device, the content server using the link; and
providing the digital content associated with the link on the second mobile device.

8. The method of claim 6, wherein the link comprises an HTTP address to access the stored digital content in the content server.

9. The method of claim 2, wherein the object comprises a connected device with the capability to be connected to a data network; and in response to providing the digital content associated with the first registered object, the method further comprises:
performing an action on the connected device in response to the digital content.

10. The method of claim 2, wherein:
processing, at the first mobile device, the first image to identify at least the first image attribute comprises processing the first image to identify a foreground object as the first image attribute; and
processing, at the second mobile device, the second image to identify at least the second image attribute comprises processing the second image to identify the foreground object as the second image attribute, the second image attribute being the same or similar to the first image attribute.

11. The method of claim 2, wherein:
processing, at the first mobile device, the first image to identify at least the first image attribute comprises processing the first image to identify a foreground object with a given background image as the first image attribute; and
processing, at the second mobile device, the second image to identify at least the second image attribute comprises processing the second image to identify the foreground object with a given background image as the second image attribute, the second image attribute being the same or similar to the first image attribute.

12. The method of claim 1, further comprising:
receiving, at a third mobile device, an image of the object;
processing, at the third mobile device, the image to identify at least a third image attribute, the third image attribute comprising an image feature or an image object;
receiving, at the third mobile device, metadata associated with the object;
registering, using the third mobile device, the object using the third image attribute as the linked image and the metadata; and
storing, at the database of registered objects, the object identified by the linked image and being associated with the metadata.

13. The method of claim 12, further comprising:
receiving, at the third mobile device, permission selection data describing the permission levels of one or more users to access the registered object in the database of registered objects.

14. The method of claim 1, wherein creating, at the first mobile device, the digital content comprises:
creating, at the first mobile device, the digital content comprising a message, the message comprising one or more of a text message, a voice message, and a video message.

15. The method of claim 1, wherein creating, at the first mobile device, the digital content comprises:
creating, at the first mobile device, the digital content comprising an electronic gift card or a food delivery order.

16. A system in a mobile device for providing digital content through objects, comprising:
an imaging sensing device configured to receive an image;
a processor;
a communication interface;
a display; and
a memory coupled with the processor, wherein the memory is configured to provide the processor with instructions which when executed cause the processor to:
receive a first image of the object;
process the first image to identify at least a first image attribute, the first image attribute comprising an image feature or an image object;
access a database of registered objects, each registered object being identified by a linked image and being associated with metadata describing the object;
retrieve from the database of registered objects a first registered object having a linked image matching the first image attribute;
in response to the retrieving, provide a user interface configured to interact with the first registered object;
receive, using the user interface, a digital content;
assign, using the user interface, the digital content to the first registered object;
designate, using the user interface, one or more recipients of the digital content; and
store in the database of registered objects linking data for the first registered object, the linking data associating the digital content to the first registered object.

17. The system recited in claim 16, wherein the memory is further configured to provide the processor with instructions which when executed cause the processor to:
activate an application; and
receive at the application the image.

18. The system recited in claim 16, wherein the memory is further configured to provide the processor with instructions which when executed cause the processor to:
receive a second image;
process the second image to identify at least a second image attribute, the second image attribute comprising an image feature or an image object;
access the database of registered objects;
retrieve from the database of registered objects a second registered object having the linked image matching the second image attribute;
in response to the retrieving, provide the user interface configured to interact with the second registered object;
determining whether the mobile device is a designated recipient of the digital content attached to the second registered object; and
in response to the determining that the mobile device is a designated recipient, provide the digital content associated with the second registered object.

19. The system recited in claim 16, wherein the object comprises an object without the capability to be connected to a data network or an object with the capability to be connected to a data network.

20. The system recited in claim 16, wherein the memory is further configured to provide the processor with instructions which when executed cause the processor to:
store the digital content in a content server; and
store, in the database of registered objects, in the metadata of the first registered object a link to a location in the content server at which the digital content is stored.
